(19) United States
(12) Patent Application Publication
(10) Pub. No.: US 2009/0102218 A1
(43) Pub. Date: Apr. 23, 2009

(54) Body Mount Assembly With Hydraulic Damping Capability

(75) Inventors: Paul M. Fernandez, Belleville, MI (US); Neil S. Cummings, Ann Arbor, MI (US); Tyler K. Boger, Novi, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/876,389

(22) Filed: Oct. 22, 2007

(51) Int. Cl. B62D 24/02

(52) U.S. Cl. 296/35.1

(57) ABSTRACT

A body mount assembly for reducing vibration between a vehicle body and a frame. The body mount includes a hydraulic radial bushing including an inner sleeve and an outer sleeve coaxial with the inner sleeve and having a hydraulic damping system disposed between the inner sleeve and the outer sleeve. A bottom retainer is positioned below a first end of the hydraulic radial bushing. An upper retainer is positioned above a second end of the hydraulic radial bushing. A flange bracket includes an axial sleeve portion coaxially surrounding the radial bushing and a plate portion extending from an end of the axial sleeve portion and including mounting apertures adapted for mounting the flange bracket to the vehicle frame. A vertical isolator is disposed between the upper retainer and the flange bracket.

### FIELD

The present disclosure relates to a vehicle body mount and more particularly, to a body mount assembly with hydraulic damping capability.

### BACKGROUND

The statements in this section merely provide background information related to the present disclosure and may not constitute prior art.

Shock absorbing body mounts are well known in the automotive industry for securing and supporting the body of a vehicle to its frame. The purpose of a body mount is to provide a tunable isolation/support element in vehicles with a body on frame construction. The body mounts act as a cushion between the occupants and the noise, vibration and impacts from the road that are transmitted through the suspension and frame. Body mounts attach to brackets that are welded to the frame rails. The body/cab is bolted to the top of the mounts.

### SUMMARY

The present disclosure provides a body mount assembly for reducing vibration between a vehicle body and a frame. The body mount includes a hydraulic radial bushing including an inner sleeve and an outer sleeve coaxial with the inner sleeve and having hydraulic fluid disposed within the hydraulic bushing for providing hydraulic radial damping. A bottom retainer is positioned below a first end of the hydraulic radial bushing. An upper retainer is positioned above a second end of the hydraulic radial bushing. A flange bracket includes an axial sleeve portion coaxially surrounding the hydraulic radial bushing and a plate portion extending from an end of the axial sleeve portion and including mounting apertures adapted for mounting the flange bracket to the vehicle frame. A vertical isolator is disposed between the upper retainer and the frame bracket.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a cross-sectional view of the body mount assembly according to the principles of the present disclosure;

FIG. 2 is a perspective view of the body mount assembly shown in FIG. 1; and

FIG. 3 is a cross-sectional view of the hydraulic radial bushing taken along line 3-3 of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

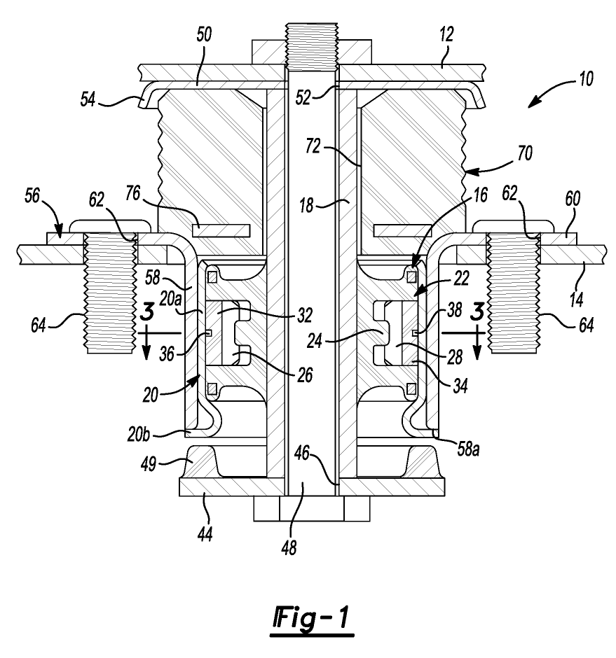

With reference to FIGS. 1 and 2, the body mount assembly 10 according to the principles of the present disclosure will now be described. The body mount assembly 10 is provided for mounting a vehicle body 12 to a vehicle frame 14.

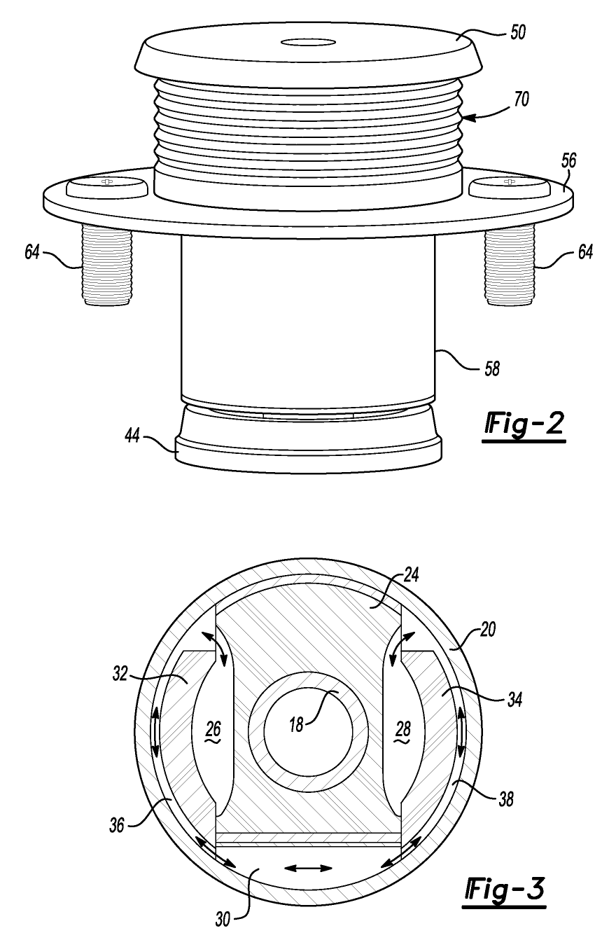

The body mount assembly 10 includes a hydraulic radial bushing 16 including an inner sleeve 18 and an outer sleeve 20 coaxial with the inner sleeve 18 and having a hydraulic damping system 22 disposed between the inner sleeve 18 and the outer sleeve 20. The inner sleeve 18 of the radial bushing 16 can be a cylindrical tube having a generally cylindrical inner wall surface and a generally cylindrical outer wall surface, although other shapes can be utilized. The outer sleeve 20 of the radial bushing 16 can include an axially extending cylindrical portion 20a spaced radially outward from the inner sleeve 18 by a predetermined amount. The outer sleeve 20 can also include a radially outwardly extending flange portion 20b extending from a lower end of the cylindrical portion 20a. A gap is defined between the inner sleeve 18 and the outer sleeve 20 of the radial bushing 16 and the hydraulic damping system 22 is provided within the gap between the inner sleeve 18 and the outer sleeve 20. With reference to FIG. 3, the hydraulic damping system 22 can include a body 24 defining first and second fluid chambers 26, 28 and a fluid track 30. The body 24 can be formed from rubber or other elastomeric material. The radial fluid track 30 extends between first and second decouplers 32, 34 which are in fluid communication with the first and second fluid chambers 26, 28, respectively. The decouplers 32, 34 each include a fluid channel 36, 38 communicating between the fluid chambers 26, 28 and the fluid track 30. The hydraulic bushing 16 provides hydraulic damping of vibrations in a radial direction. In particular, as the outer sleeve 20 is moved toward the inner sleeve 18 due to vibrations, the fluid in one fluid chamber 26, 28 can become compressed causing the fluid in the one fluid chamber 26, 28 to flow through the respective fluid channels 36, 38 of the decouplers 32, 34, through the fluid track 30 and to the other fluid chamber. The restriction on the fluid flow by the narrow fluid channels 36, 38 of the decouplers 32, 34 causes a damping effect on the vibrations transmitted through the hydraulic radial bushing 16.

A bottom retainer 44 is positioned below a lower end of the hydraulic radial bushing 16. The bottom retainer 44 can be formed from metal or other material and can include a central aperture 46 for receiving a mounting bolt 48 of the body mount assembly 10. An elastomeric bumper portion 49 can be provided on an upper surface of the bottom retainer. An upper retainer 50 is positioned above a second end of the hydraulic radial bushing 16. The upper retainer 50 can be made from metal or other materials, and can include a central aperture 52 for receiving the bolt 48 therein. The upper retainer 50 can include a bent axial flange 54 disposed at a radially outermost portion of the upper retainer 50.

A flange bracket 56 includes an axial sleeve portion 58 co-axially surrounding the hydraulic radial bushing 16 such that the axial portion 20a of the outer sleeve 20 of the hydraulic radial bushing 16 is in close proximity to the axial portion 58 of the flange bracket 56. The flange bracket 56 also includes a plate portion 60 extending radially outward from an end of the axial sleeve portion 58 and including mounting apertures 62 for receiving mounting bolts 64 for mounting the flange bracket 56 to the vehicle frame 14. The axially extending portion 58 of the flange bracket 56 can have an end portion 58a disposed against the radially extending flange portion 20b of the outer sleeve 20 of the radial bushing 16.

A vertical isolator 70 can be located between the upper retainer 50 and the flange bracket 56. The vertical isolator 70 can have a generally cylindrical shape with a generally cylindrical inner surface 72 to receive the inner sleeve 18 of the hydraulic radial bushing 16. A plate/washer 76 can be molded into the lower portion of the vertical isolator 70 or otherwise disposed between a bottom surface of the vertical isolator 70 and the frame bracket 56. The vertical isolator 70 can be made from a microcellular urethane, or can be formed from other known vibration isolation materials.

It should be noted that the height and diameter of the vertical isolator 70 can be specifically tuned to a specific application. Furthermore, the size and shape of the fluid passages of the hydraulic radial bushing 16 can be varied in order to provide desired lateral and fore/aft vibration characteristics.

What is claimed is:

1. A body mount assembly for connection between a vehicle body and frame, comprising:
a hydraulic radial bushing including an inner sleeve and an outer sleeve coaxial with said inner sleeve and having a hydraulic damping system disposed between said inner sleeve and said outer sleeve;
a bottom retainer positioned below a first end of said radial bushing;
an upper retainer positioned above a second end of said radial bushing;
a flange bracket including an axial sleeve portion coaxially surrounding said radial bushing and including a plate portion extending from an end of said axial sleeve portion and including mounting apertures adapted for mounting said flange bracket to the vehicle frame; and
a vertical isolator disposed between said upper retainer and said frame bracket.

2. The body mount according to claim 1, wherein said hydraulic radial bushing includes an elastomeric body defining a pair of fluid chambers disposed on opposite sides of said inner sleeve.

3. The body mount according to claim 2, wherein said hydraulic radial bushing includes a pair of decouplers communicating with said pair of fluid chambers, said pair of decouplers each including a fluid channel in communication with a fluid track defined by said elastomeric body.

4. The body mount according to claim 1, wherein said outer sleeve of said radial bushing includes a radially extending flange extending from a lower end of said outer sleeve.

5. The body mount according to claim 4, wherein said bottom retainer includes elastomeric material attached to an upper surface opposite said radially extending flange of said outer sleeve.

6. The body mount according to claim 1, wherein said elastomeric body of said hydraulic radial bushing is molded to said inner sleeve.

7. The body mount according to claim 1, wherein said vertical isolator is made from microcellular urethane, or other elastomeric material.

8. The body mount according to claim 1, further comprising a plate disposed between said vertical isolator and said bracket.

9. The body mount according to claim 1, wherein said inner sleeve of said hydraulic radial bushing and said upper and bottom retainers each include a central aperture therein.

10. A body mount assembly for connection between a vehicle body and frame, comprising:
a hydraulic radial bushing including an inner sleeve and an outer sleeve coaxial with said inner sleeve and having a hydraulic damping system between said inner sleeve and said outer sleeve, said outer sleeve of said hydraulic radial bushing includes a radially extending flange extending from a lower end of said outer sleeve;
a bottom retainer positioned below a first end of said hydraulic radial bushing wherein said bottom retainer includes an elastomeric bumper disposed opposite radially extending flange of said outer sleeve of said hydraulic radial bushing;
an upper retainer positioned above a second end of said hydraulic radial bushing;
a flange bracket including an axial sleeve portion coaxially surrounding said hydraulic radial bushing and including a plate portion extending from an end of said axial sleeve portion and including mounting apertures adapted for mounting said flange bracket to the vehicle frame; and
a vertical isolator made from microcellular urethane or other elastomeric material and disposed between said upper retainer and said flange bracket.

11. The body mount according to claim 10, further comprising a plate disposed between said vertical isolator and said flange bracket.

12. The body mount according to claim 10, wherein said inner sleeve of said hydraulic radial bushing and said upper and bottom retainers each include a central aperture therein.

13. The body mount according to claim 10, wherein said hydraulic radial bushing includes an elastomeric body defining a pair of fluid chambers disposed on opposite sides of said inner sleeve.

14. The body mount according to claim 13, wherein said hydraulic radial bushing includes a pair of decouplers communicating with said pair of fluid chambers, said pair of decouplers each including a fluid channel in communication with a fluid track defined by said elastomeric body.
